(19) United States
(12) Patent Application Publication
(10) Pub. No.: US 2019/0087436 A1
(43) Pub. Date: Mar. 21, 2019

(54) INTERACTIVE DIGITAL INFRASTRUCTURE APPLICATION

(71) Applicant: Always Education, LLC, Cincinnati, OH (US)

(72) Inventors: Valiyolah Tadayon, Cincinnati, OH (US); Fariborz Grayli, Cincinnati, OH (US)

(21) Appl. No.: 15/706,037

(22) Filed: Sep. 15, 2017

(51) Int. Cl. G06F 17/30; G09B 5/14; G09B 5/12; G09B 5/06

(52) U.S. Cl. CPC G06F 17/30126; G06F 17/30221; G06F 3/0482; G09B 5/125; G09B 5/06; G09B 5/14

(57) ABSTRACT

The invention provides an interactive digital infrastructure application with a first hierarchical data structure, a populous data structure, and a network-based, interactive software tool with access to the data structures. The hierarchical data structure includes a plurality of hierarchical levels, including a higher institutional level with at least one institutional file pertaining to an institution, an intermediate geographic level with geographic files pertaining to geographic locations associated with the institution, and a lower resource level having resource files pertaining to resources associated with the geographic locations. The interactive software tool includes an interactive graphical user interface dashboard displaying information from files within databases and allows users to navigate the files. Exemplary embodiments provide a logical layer interface between a legacy database silo and first hierarchical data structure providing access to information in the legacy database silo for display in the dashboard and linking relationship logic for files within data structures.

### FIELD OF THE INVENTION

The present disclosure relates generally to digital infrastructure for the exchange of information between individuals in an institution. The disclosure provides a digital infrastructure application for an institution with one or more hierarchical data structures and a network-based interactive software tool with access to the data structures displaying information from files stored on the data structure through an interactive graphical user interface dashboard.

### BACKGROUND OF THE INVENTION

Current institutional digital infrastructures generally consist of individual siloed databases storing institutional information. While database software allows users to individually access the information within each database, with a plurality of databases, a user needing information from multiple databases would have to search each database for the information sought after.

Further, the siloed databases may vary in terms of user access. While one user may have access to a certain database that same user may not have access to another database making the search for relevant information more time consuming if the help of another individual with access to that database is required or otherwise the search would be incomplete if access to the other database is never found.

Additionally, related information stored in files of multiple databases is not linked, and thus locating one piece of information relevant information does not automatically lead to relevant information in the other database and a new search of the second database is required.

One example of a digital infrastructure used in an institution is the learning management system (“LMS”) used by educational institutions. An LMS is a software system used for the administration, documentation, tracking, reporting and delivery of educational courses or training programs. Instructors may use the LMS to deliver instructional material to students, administer tests and other assignments, track student progress, and manage record keeping. An LMS may be used as a platform for fully online courses at an institution. The LMS may also contain a teacher and student role and provides the teacher with the ability to teach courses though the LMS system by providing the teacher the ability to build a syllabus for a course, an assignment builder for the course, a rubric and gradebook function for the course, and provides the teacher with various communication systems with students associated with the course. However, while the LMS system improved the exchange of information between teachers and students in educational institutions, the LMS system still has the same shortcomings as described above. Information gathered through the LMS is stored in siloed databases where related information is not associated with one another.

Thus, there remains a need for an interactive digital infrastructure application that is able to incorporate all of the information stored in the siloed databases of an institution, to associate the information stored in the files of these databases in a relevant and useful way, and to provide access and use of this information to individuals of the organization to maximize the exchange of the information.

### SUMMARY

Embodiments of the current disclosure are directed to an interactive digital infrastructure application with a first hierarchical data structure (the institutional hierarchy or data structure), a populous data structure and a network-based, interactive software tool with access to both data structures. The first institutional hierarchical data structure contains hierarchical levels including an institutional level with an institutional file pertaining to an institution, an intermediate geographic level and/or an intermediate sub-institutional level with associated geographic/sub-institutional files pertaining to the geographic locations and/or sub-institutions associated with the institution, and a lower resource level with resource files pertaining to the resources associated with the geographic locations and/or sub-institutions. The populous data structure contains individual files of the individual people associated with the institution. The network-based, interactive software tool includes an interactive graphical user interface dashboard that displays information from the files within the data structures. The dashboard also displays navigation objects pertaining to the hierarchical files above or below the files in the hierarchical data structure to allow a user to navigate through files in the data structure by activating the navigation objects in the dashboard display. The dashboard may also displays navigation objects pertaining to files in the populous data structure to allow a user to navigate across files between the two data structures by activating the navigation objects in the dashboard display.

In another embodiment the interactive digital infrastructure application also includes a logical layer interface between a legacy database silo and the first hierarchical data structure and provides access by the hierarchical data structure to information in the legacy database silo.

In another embodiment the populous data structure is a second hierarchical data structure where the levels of the data structure pertain to the roles of the individuals in the institution and the individual files include identities of files above and/or below the individual files in the second hierarchical data structure. The interactive graphical user interface dashboard also displays information from files in the populous data structure and displays navigation objects pertaining to the individual files above and/or below an individual file to allow a user to navigate through files in the populous data structure. The dashboard may also displays navigation objects pertaining to files back in the hierarchical data structure to allow a user to navigate across files between the two data structures by activating the navigation objects in the dashboard display.

Each file may contain information pertaining to the particular hierarchical data structure element to which the file is associated. For example, the institutional file will contain information pertaining to the institution to which the file is associated; each geographic file will contain information pertaining to the specific geographical location to which the file is respectively associated; each resource file will contain information pertaining to the specific resource to which the file is respectfully associated; each sub-institutional file will contain information pertaining to the sub-institution to which the file is associated; and each populous file will contain information pertaining to the specific person or role to which the file is respectfully associated. Additionally, each file may contain traversing links to one or more files upper and/or lower in the hierarchy; and each file may also contain cross-links across hierarchies. For example, the institution file may contain traversing links to geographic files below the institution file in the hierarchy (such as office or building locations within the institution); and may also contain cross-links to upper management associated with the institution in populous files from the populous hierarchy. As another example, a geographic file for a certain building may contain traversing links to files above it and below it in the hierarchy (such as institutional file(s) above and resource file(s) below) and may contain cross-links to files of personnel responsible for certain activities, management and/or maintenance of the building in the populous hierarchy. Likewise, files in the populous hierarchy may include similar traversing-links (up and down hierarchy) as well as cross-links.

In a particular embodiment the institution is a school, the geographic locations include buildings or rooms within the school or campus, sub-institutions include internal departments or classes, and resources include equipment or furniture within the geographic locations. In this embodiment, the levels within the populous data structure include an administrative level, a teacher level, a student level, an alumni level, an employee level, and a vendor level. Further, individuals in the teacher level are able to create and share files and the information in such files may include class schedule information, curriculum information, and assignment information.

In further embodiments, the populous hierarchical data structure can also include a group level with a plurality of group files of the groups formed between individuals in the institution or an event level with event files for the events occurring at the institution.

In another embodiment the interactive digital infrastructure application includes a social networking logical layer interface between at least one social networking system and the populous data structure providing access to information on the social networking system by the populous data structure.

In another embodiment, the resource information of a resource file includes warrantee information, user information, vendor information, service schedule information, or geographic location information.

In a further embodiment, the interactive digital infrastructure application includes a resource tracker that tracks the location of a resource and updates the first hierarchical database to a change in the location information of the resource.

It is another aspect of the current disclosure to provide an interactive digital infrastructure application that includes (1) a first hierarchical data structure including a plurality of hierarchical levels, including at least two of, a. a higher institutional level having at least one institutional file pertaining to an institution, b. an intermediate geographic level having a plurality of geographic files pertaining to geographic locations associated with the institution, c. an intermediate sub-institutional level having a plurality of sub-institutional files pertaining to sub-institutions within the institution, and d. a lower resource level having a plurality of resource files pertaining to resources associated with the geographic locations; (2) a populous data structure including a plurality of individual files pertaining to individual people associated with the institution, said plurality of individual files including information pertaining to each individual's role within the institution; and (3) a network-based, interactive software tool having access to the first hierarchical data structure and to the populous data structure, the software tool providing an interactive graphical user interface dashboard accessible to each of the individual people associated with the institution; where the interactive software tool includes a social network application that has been automatically established for the plurality of individuals based, at least in part, upon each individual's role within the institution.

In a more detailed embodiment, the social network application automatically assigns each individual to at least one social network group based upon the individual's role within the institution. Alternatively, or in addition, the social network application automatically assigns each individual to access to one or more hierarchical levels within the first hierarchical data structure based upon the individual's role within the institution. Alternatively, or in addition, the social network application automatically assigns each individual to one or more categories of messaging based upon the individual's role within the institution. Alternatively, or in addition, the social network application automatically assigns each individual access to a sub-set of information within the first hierarchical data structure based upon the individual's role within the institution.

In a more detailed embodiment, the social network application automatically assigns institutional connections between the plurality of individuals based, at least in part, upon the individuals' roles within the institution. In a further detailed embodiment, the social network application automatically reassigns institutional connections between the plurality of individuals based, at least in part, upon changes to the individuals' roles within the institution. In a further detailed embodiment, the social network application assigns voluntary connections (e.g., “Always Friends”) between the plurality of individuals based upon users' interactions with the social network application and wherein the social network application does not reassign the voluntary connections based upon changes to the individuals' roles within the institution

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 is a block diagram showing the interactive digital infrastructure application;

FIG. 2 is a schematic representation of hierarchical levels in a hierarchical data structure according to an embodiment of the present invention;

FIG. 3 illustrates a connection of legacy database silos of an institution through a logical layer interface according to an embodiment of the present invention;

FIG. 4 is a schematic representation of a screenshot of a user interface dashboard illustrating where information from legacy database silos are displayed on the dashboard according to an embodiment of the present invention;

FIG. 5 is an exemplary screen shot of a dashboard display for an individual within an institution displaying information from files from one level of a hierarchical data structure according to an embodiment of the present invention;

FIG. 6 is another exemplary screen shot of a dashboard display for an individual within an institution displaying information from files from one level of a hierarchical data structure according to an embodiment of the present invention;

FIG. 7 is another exemplary screen shot of a dashboard display for an individual within an institution displaying information from files from one level of a hierarchical data structure according to an embodiment of the present invention;

FIG. 8 is another exemplary screen shot of a dashboard display for an individual within an institution displaying information from files from one level of a hierarchical data structure according to an embodiment of the present invention;

FIG. 9 is another exemplary screen shot of a dashboard display for an individual within an institution displaying information from files from one level of a hierarchical data structure according to an embodiment of the present invention;

FIG. 10 is an exemplary screen shot of a dashboard display for an individual within an institution displaying a communication screen according to an embodiment of the present invention; and

FIG. 11 is an exemplary screen shot of a dashboard display for an individual within an institution displaying information from files from one level of a hierarchical data structure according to an embodiment of the present invention;

FIG. 12 is a schematic diagram of example associations of the object files in the hierarchical levels within hierarchical data structures according to an embodiment of the present invention;

FIG. 13 is a schematic representation of an example file system according to an embodiment of the present invention;

FIG. 14 is a schematic representation of file system according to an embodiment of the present invention; and

FIG. 15 is a schematic representation of file system according to an embodiment of the present invention.

### DETAILED DESCRIPTION

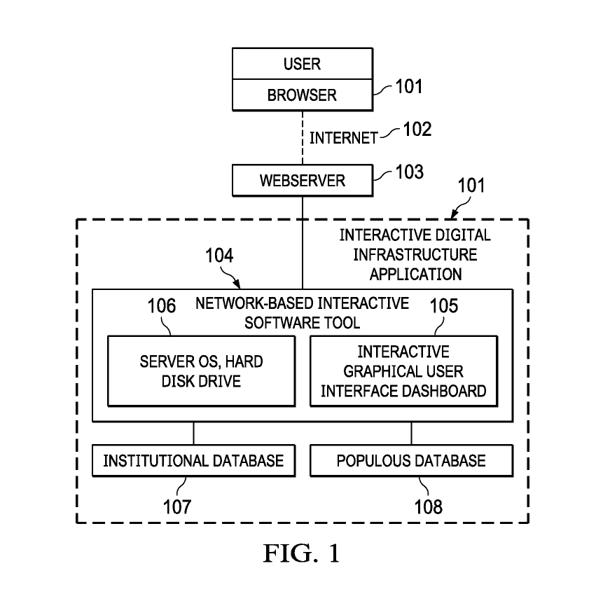

Generally, the present disclosure provides an interactive digital infrastructure application for an institution where data files are stored in hierarchical levels of a data structure with a software tool that allows a user to navigate through files of the hierarchical data structure. As shown in FIG. 1, a user accesses the interactive digital infrastructure using a personal computer platform 101 having a browser software program. The browser is in communication with the Internet 102, through an Internet Service Provider (“ISP”), which communicates with a web server 103. Through the web server 103, the interactive digital infrastructure application 100 is accessed. Specifically, the interactive digital infrastructure application 100 includes a hierarchical institutional data structure (shown as institutional database) 107, a populous data structure (shown as populous database, which may also be hierarchical) 108, and a network-based, interactive software tool 104.

The institutional data structure 107 may include a plurality of hierarchical levels, including a higher institutional level, intermediate geographic level(s), sub-institutional levels and lower resource level(s). The institutional level contains at least one institutional file pertaining to an institution. The intermediate geographic level(s) contains a plurality of geographic files pertaining to geographic locations associated with the institution (e.g., a university, corporation, or business, etc.). Sub-institutional level(s) contain sub-institutions within the institution (e.g., a department, an internal school, a subsidiary, etc.). The lower resource level(s) contains a plurality of resources files pertaining to resources associated with the geographic locations and/or sub-institutional levels.

For example, in one particular embodiment the institution is a university or college. The geographic locations in this embodiment may include the campuses, buildings and/or class-rooms, for example, located in the university. The resources for the geographic locations may include, for example, the furniture, computers, printers/copiers, books, air-conditioners, and the like, in or associated with the geographic locations of the university. The sub-institutional levels, for example, may include colleges/schools within the university, departments within the colleges/schools and classes within the departments/schools. Further, the resources for the sub-institutional levels may include the class syllabus, the assignments, the schedule and the like, for the respective class. In this example, the populous data structure 108 may include a plurality of individual files pertaining to individual people associated with the university, including the staff, faculty, students, students'-parents, alumni, donors and the like. The network based, interactive software tool 104 accesses the hierarchical institutional data structure 107 and the populous data structure 108 and provides an interactive graphical user interface dashboard 105 that is accessible to each of the individuals associated with the institution. The network based, interactive software tool 104, of course, will also contain computing resources 106 such as a server, operating system, memory drives and the like.

The institutional file in the institutional level of the institutional data structure 107 includes institution information and identities (and traversing links) of files in the next lower hierarchical level of the hierarchical data structure. The geographic files and/or sub-institutional files include associated geographic and/or sub-institutional information, identities (and traversing links) of files in a next upper hierarchical level of the data structure, and identities (and traversing links) of files in a next lower hierarchical level of the hierarchical data structure. The resource files include associated resource information and identities (and traversing links) of files in a next upper hierarchical level in the hierarchical data structure. The user interface dashboard 105 of the interactive software tool 104 displays information from at least one file in the hierarchical data structure. The dashboard 105 also displays navigation objects pertaining to hierarchical files above and/or below the file and allows a user of the interface tool to navigate through the files of the data structure by activating the navigation objects in the dashboard display.

In another embodiment, the populous data structure 108 may also be a second hierarchical data structure where the levels in the populous data structure may pertain to roles of the individuals associated with the institution. For example, roles of individuals in an educational institution may include an administrator, president, vice president, provost, dean, associate dean, academic director, staff, faculty, academic designer, instructional designer, student, and alumni. Each individual file within the populous data structure 108 includes information pertaining to the individual and includes identities (and traversing links) of files above and/or below the individual file in populous data structure 108. As will be discussed in further detail below, various access, permissions, automatic social network connections, automatic group affiliations, messaging access and the like may depend upon the user's defined role within the populous data structure 108.

In an embodiment, the populous data structure 108 is not necessarily a hierarchical data structure. For example, every individual may have one or more files in the data structure that include information pertaining to the individual, such as identification information, role(s) within the institution, social network connections, group memberships, file access, messaging information feeds and the like.

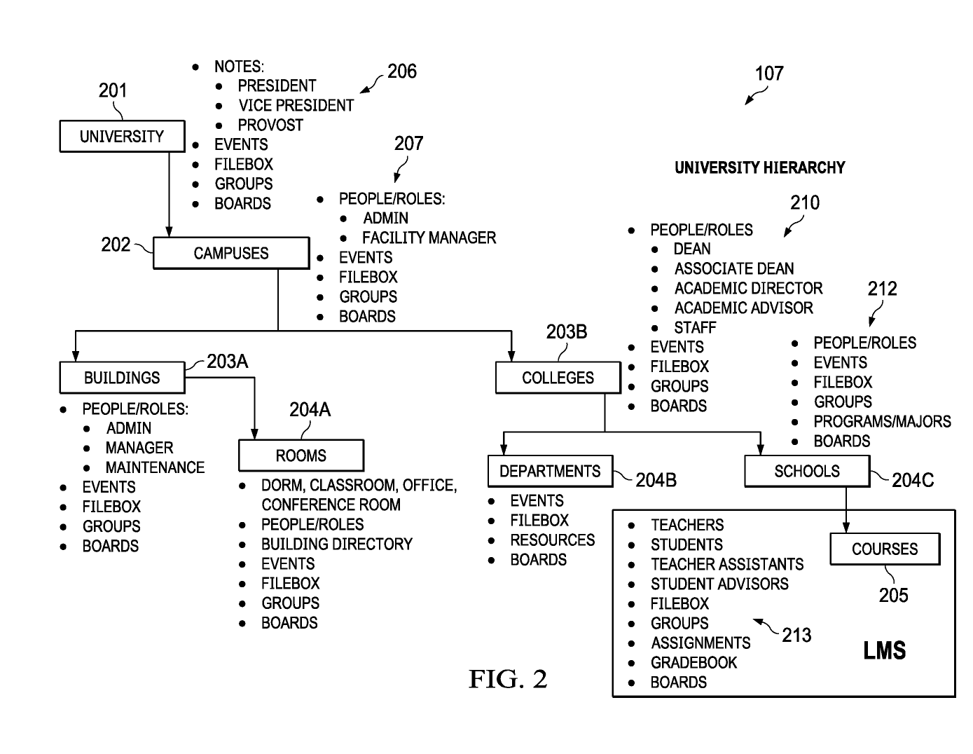

FIG. 2 is a schematic representation of exemplary hierarchical levels in an institutional data structure 107 according to one embodiment of the present invention, in particular, an interactive digital infrastructure application for a University. A higher institutional level in this particular embodiment is a University level 201 with at least an institutional file 206 associated therewith, pertaining to the university. A first intermediate geographic level, Campuses 202, includes a plurality of geographic files 207 pertaining to the campuses located on the university. A second intermediate geographic level, Buildings 203(a), is a lower level from the Campuses 202 level that includes a plurality of geographic files 208 pertaining to the buildings located on each campus. A second intermediate geographic level, Rooms 204(a), is a lower level from the Buildings level with a plurality of room files 209 pertaining to the rooms in each building in the Buildings level. Further, a lower resource level (not shown) may also be included—Equipment—that is below the Room level and includes a plurality of equipment files pertaining to the computers, projectors, printers and the like located within each room at the Room level 204(a). A branching hierarchy level may be an intermediate sub-institution level, Colleges 203(b), also at a lower level from the Campuses level 202 and includes a plurality of college files 210 pertaining to colleges associated with each campus. A fourth intermediate sub-institutional level below the Colleges level is a Departments level 204(b) having a plurality of department files 211 pertaining to the departments within each college. A fifth intermediate sub-institutional level below the Colleges level 203(b) is a Schools level 204(c) having a plurality of school files 212 pertaining to the schools within each college. A lower Courses level 205 below the Schools level 204(c) contains a plurality of course files 213 pertaining to the courses associated with each school. Finally, a lower resource level (not shown) may be included below the Courses level 205, which may include resources for the course such as schedules, assignments, study materials, lecture slides, homework assignments, syllabuses and the like.

As can be further seen in FIG. 2, the files 206-213 associated with the hierarchical levels in the institutional data structure 107 may include a plurality of elements. Files associated with the hierarchical levels in the institutional data structure 107 may include cross-links and/or identification of individuals in the populous data structure 108 who may have specific roles relating to the respective hierarchical element. For example, the file 206 associated with the institutional level University 201 may include cross-links and/or identification of the President of the University, the Vice President and the Provost; the file 208 associated with the geographic level Buildings 203(a) may include cross-links and/or identification of the building administrator, the building manager and individual(s) associated with building maintenance; and the file 210 associated with the sub-institutional level Colleges 203(b) may include cross-links and/or identification of the College Dean, the Associate Dean, Academic Advisor(s) and staff member(s). Files associated with the hierarchical levels in the institutional data structure 107 may further include cross-links, identification and/or information pertaining to Events associated with the specific hierarchical element in the data structure 107; files associated with the hierarchical levels in the institutional data structure 107 may further include cross-links, identification and/or information pertaining to social-network Groups associated with the specific hierarchical element in the data structure 107; and files associated with the hierarchical levels in the institutional data structure 107 may further include cross-links, identification and/or information pertaining to message Boards associated with the specific hierarchical element in the data structure 107. Finally, each file associated with the hierarchical levels in the institutional data structure 107 may further include a FileBox allowing individuals associated with (and having authorized access to) the particular hierarchical elements in the institutional data structure 107 (e.g., having roles associated with the particular hierarchical elements) to upload and/or download data, such as document files, audio-visual files, and the like, so that other individuals may be able to access the same through the graphical user interface 105.

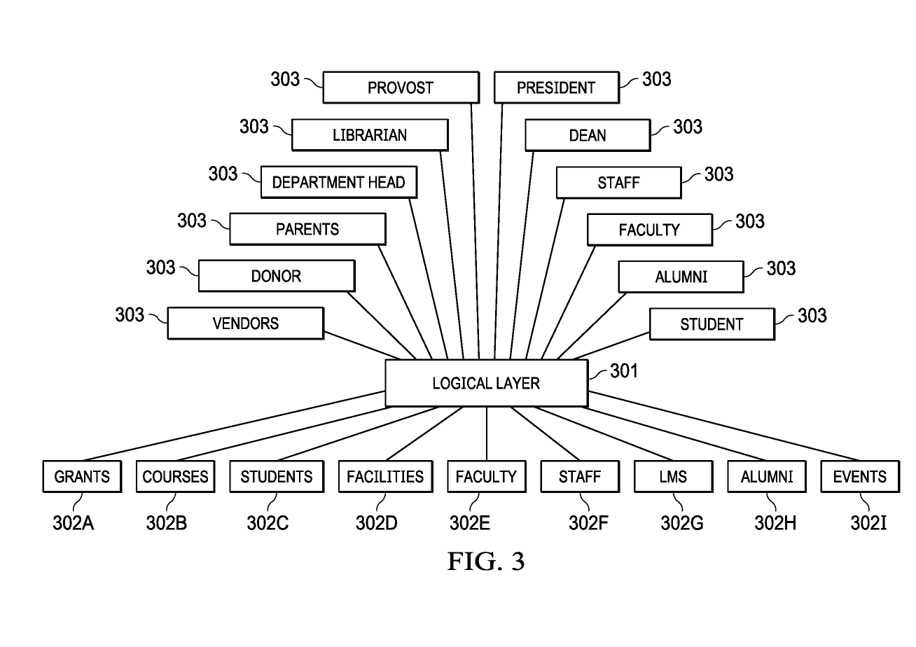

FIG. 3 shows a plurality of legacy database silos that may exist in an institution, and more particularly in an educational institution. Example legacy database silos include: a grants database silo 302A with grant files with information pertaining to the grants obtained by teachers at the educational institution; a courses database silo 302B containing course files with information pertaining to all of the courses that have been and are offered at the institution; a students database silo 302C with student files with information pertaining to the students attending the educational institution; a facilities database silo 302D with facility files with information pertaining the facilities located on the educational institution; a faculty database silo 302E with faculty files pertaining to the faculty of the institution; a staff database silo 302F with staff files with information pertaining to the staff employed by the educational institution; an LMS database silo 302G with LMS files pertaining LMS information from an LMS system used by the institution; an alumni database silo 302H with alumni files with information pertaining to students who have graduated from the educational institution; and an events database silo 302I with event files with information pertaining to the events occurring at the institution. These database silos typically are isolated from one another and a user searching for information located on multiple database silos would be required to search each database silo separately. An embodiment of the interactive digital infrastructure application of the present disclosure further comprises a logical layer interface 301 between the legacy database silos 302(a)-302(i) and the first hierarchical data structure 107 where the logical layer interface 301 provides access to the information in the legacy database silos for incorporating such information with the hierarchical database structure providing the hierarchical levels to the information of the legacy database silos. A user 303 manipulates the interactive graphical user interface dashboard 105 to display information from within the separate legacy database silos 302A-302I. The information from the legacy database silos are organized in the first hierarchical data structure 107 or populous data structure 105 in the corresponding hierarchical levels. Users 303 may include any individual associated with the educational institution from a student to the president of the institution. Further, information from the legacy database silos 302A-302I may be retrieved in batches or in real-time. The logical layer interface 301 includes preset access information (e.g., user-names, passwords, protocols, decryption keys and the like) allowing access to and communication with each of the individual silos 302A-302I, and further contains any necessary protocols, interfaces or authorizations for each 302A-302I. In another embodiment, the interactive digital infrastructure application may also include a second logical layer interface for accessing external assets (such as information from third party networks and databases). One example of such a second logical layers includes a social networking logical layer interface between a social networking system and the populous data structure that provides access to the information on a social networking system by the populous data structure. Information from the social networking system associated with the individuals of the institution may also be displayed by the dashboard 105.

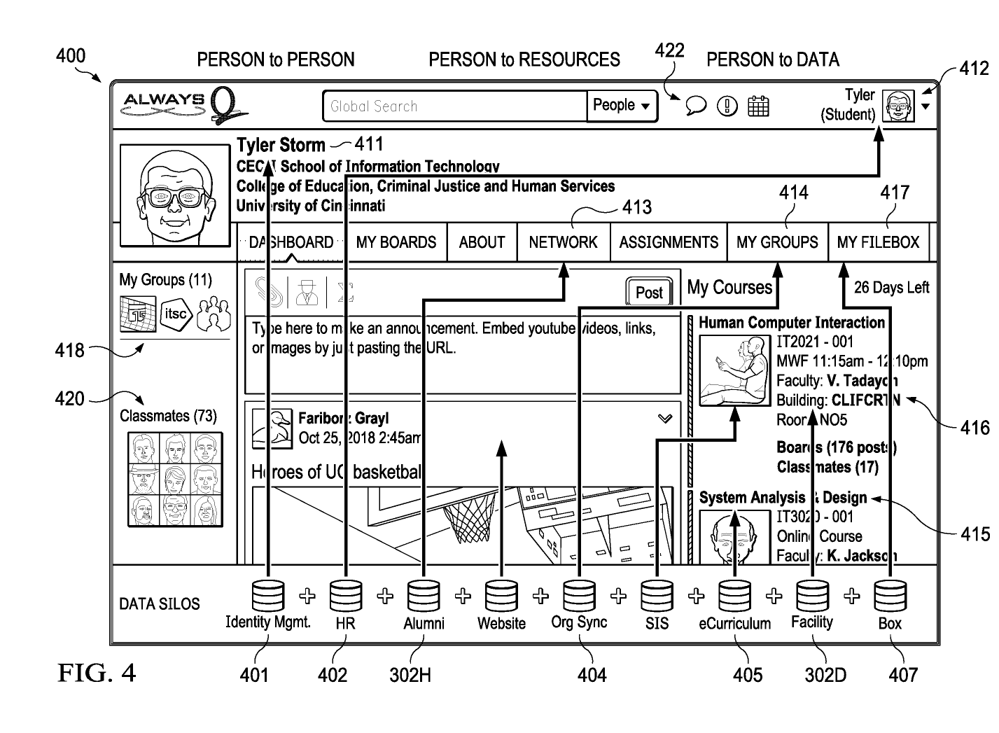

FIG. 4 shows a schematic representation with an example screen shot of the user interface dashboard display 400 (provided by the graphical user interface 105) where information from separate legacy database silos are consolidated in the dashboard display 400 of the interactive digital infrastructure application. At least some information from a file within the Identity Management database silo 401 is displayed on the biographical section 411 of the dashboard display 400. Information from a file within the Human Resources database silo 402 is displayed on the role section 412 of the dashboard display 400. Information from a file within the Alumni database silo 302H may be used to populate a Network navigation object 413 on the dashboard display 400 that a user can activate to navigate, and network with alumni based upon the information contained in a particular Alumni file. Information from a file within the Organizational Sync database silo 404 is available through the My Groups navigation object 414 on the dashboard display 400 allowing the user to network with individuals based upon a groups-level access. Information from a file within the Curriculum database silo 405 is displayed on the curriculum section (“My Courses”) 415 of the dashboard display 400. Information from a file within the Facility database silo 320D is also displayed curriculum section 415 of the dashboard display 400. Information from files within the Box database silo 407 is available through the My FileBox navigation object 417 on the dashboard display 400 that the user can activate to navigate to information contained in a particular FileBox as will be explained below.

FIG. 4 also illustrates the ability of the current embodiment to allow a user to navigate within and across the various hierarchical data structures (person to person; person to resources; person to data). The dashboard display 400 shown in FIG. 4 is of an individual. The biographical section 411 includes the individual's name, the identity of the school(s) that the individual is enrolled (sub-institutional level), as well as the university (institutional level). Each of the sub-institutional level identities (schools/colleges) provided in the biographical section 411 is an active area (or hyperlink or similar area) that will cause the system to navigate to a page/window/GUI specific to the particular sub-institutional level; and the institutional level identity (university) provided in the biographical section 411 is an active area (or hyperlink or similar area) that will cause the system to navigate to a page/window/GUI specific to the particular institutional level. The curriculum section 415 of the dashboard display 400 for the individual is also a good example of person-to-resources and person-to-data access. For example, the sub-institutional level identity of each class within the curriculum section 415 is an active area (or hyperlink or similar active area) that will cause the system to navigate to a page/window/GUI specific to the particular sub-institutional level; the geographic level identity of the building 416 holding the particular class is an active area (or hyperlink or similar area) that will cause the system to navigate to a page/window/GUI specific to the particular geographic level; and the populous identity of the professor provided in the curriculum section 415 is an active area (or hyperlink or similar area) that will cause the system to navigate to a page/window/GUI specific to the particular individual.

FIG. 4 also illustrates aspects of the social networking mechanisms contemplated by the disclosed embodiment. According to the current disclosure the interactive digital infrastructure application is configured to automatically generate various access, permissions, social network connections, group affiliations, messaging access and the like depending upon the user's defined role. For example, the interactive digital infrastructure application may automatically assign the user to certain social network groups 418 based upon the user's role as a student within a certain department and/or within a certain class or schedule. The digital infrastructure may also automatically assign the user to certain social network connections, such as classmates 420, based upon the user's role as a student within certain departments and/or within a certain class or schedule. By automatically and intelligently assigning each user to various access, permissions, social network connections, group affiliations, facilities, resources, messaging access and the like depending upon the user's defined role, the users instantly have access to all resources and information needed to succeed within the institution on their dashboard display 400. For example, by signing up to their first school course of study, the user will automatically belong to a social network, for each course, of fellow students, staff, advisors, administrators and the like. As another example, by being assigned to a room in a dormitory, the user will automatically belong to a social network for floor or hallway on which the student is assigned. The role designation area 412 provides a pull-down menu allowing the user to access other roles the user has within the institution (e.g. person may have a role as both a student of the educational institution and an employee of the educational institution). When the role is thus changed, the user's automatic associations and access will also change according to the different role. Tools 422 available to the user will also depend upon the role of the user.

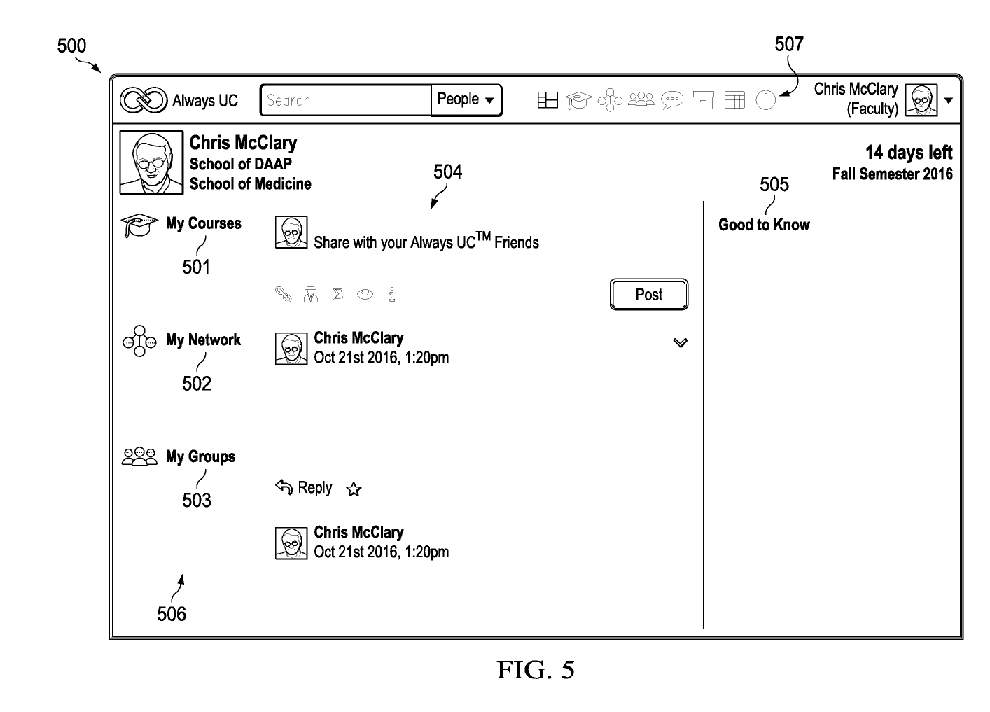

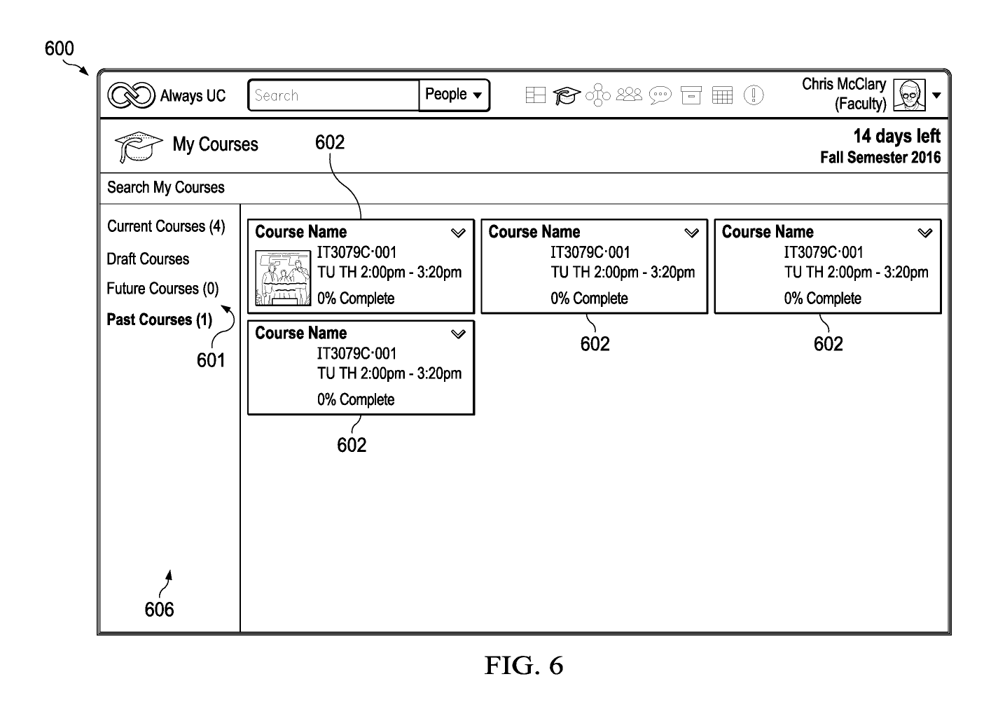

FIG. 5 shows an example screenshot of a dashboard display 500 for a user of an educational institution embodiment. Specifically, the dashboard display 500 is for an individual in a faculty role of the institution as designated in the role section of the dashboard display. The example dashboard display includes a navigation section 506 with active areas, My Courses 501, My Network 502, and My Groups 503 where activation of the particular object navigates the user to the respective components of the user's dashboard (e.g., activating the My Courses object 501 will navigate the user to a My Courses dashboard as shown in FIG. 6). The dashboard 500 includes a message area 504 where the user can review and generate messages to individuals in the user's network and/or groups. A “good to know” section 505 of the dashboard display provides the user with suggestions, reminders, alarms, news items or other relevant information determined by the interactive software tool to be relevant to the user at the particular time and place. The tools 507 available to the faculty member are different than those available to the student as discussed above in FIG. 4.

FIG. 6 shows an example screen shot of a “my courses” dashboard display 600 for an individual from FIG. 5 where the “My Courses” link/active-area 501 was activated. Upon activation, the dashboard display 600 displays the current courses the user associated with. The courses are displayed with navigation objects 602 where activation of the navigation object (link or active-area) for the course displays additional levels and information within the course. The navigation area 606 of the display 600 allows the user to further drill down to particular types of courses (current, draft, future and past, for example) 601.

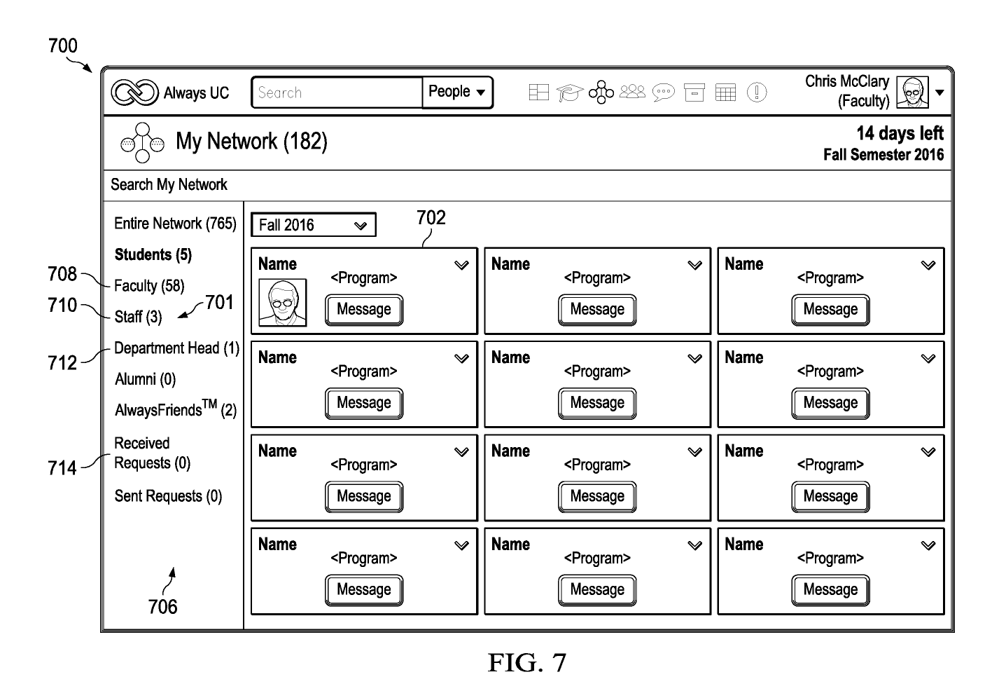

FIG. 7 shows an example screen shot of a “my network” dashboard display 700 for an individual from FIG. 5 where the “My Network” link/active-area 502 was activated. Upon activation, the dashboard display 700 displays individuals that the user associated with. The associated individuals are displayed with navigation objects 702 where activation of the navigation object (link or active-area) for the course displays additional levels and information associated with the individual. The navigation area 706 of the display 700 allows the user to further drill down to particular subsets of associated individuals (entire network, students, faculty, etc.) 701.

FIG. 7 also illustrates more of the automatic social networking aspects of the current disclosure. As discussed above, upon being assigned a certain role within the populous data structure 108, the interactive digital infrastructure application may be configured to automatically generate various access, permissions, social network connections, group affiliations, messaging access and the like depending upon the user's defined role. For example, the interactive digital infrastructure application may automatically assign social network connections to the user based upon the user's role as a member of faculty. As shown in FIG. 7, such automatic social network connections may include other faculty members within the same department 708, other staff associated with the faculty member's course schedule 710, the faculty member's department head 712 and so forth. In an embodiment, some of these automatic social network connections may automatically change based upon periodic changes in the user's role and/or upon other changes, such as the start of a new term. Nevertheless, embodiments of the current disclosure allow users to request and accept long-term social network connections that will not automatically change based upon changes to the user's role or based upon periodic changes to the user's status. Such voluntary social network connections are shown as “Always Friends” 714; while Received Requests 716 and Sent Requests 718 for “Always Friends” 714 are also illustrated. Such voluntary social network connections 714 will remain with the user so long as each connection allows the connection to remain. In the current example, the faculty member may establish an Always Friends connection to a student, and as the student graduates and becomes alumni (changes roles) the connection will remain so long as each party desired.

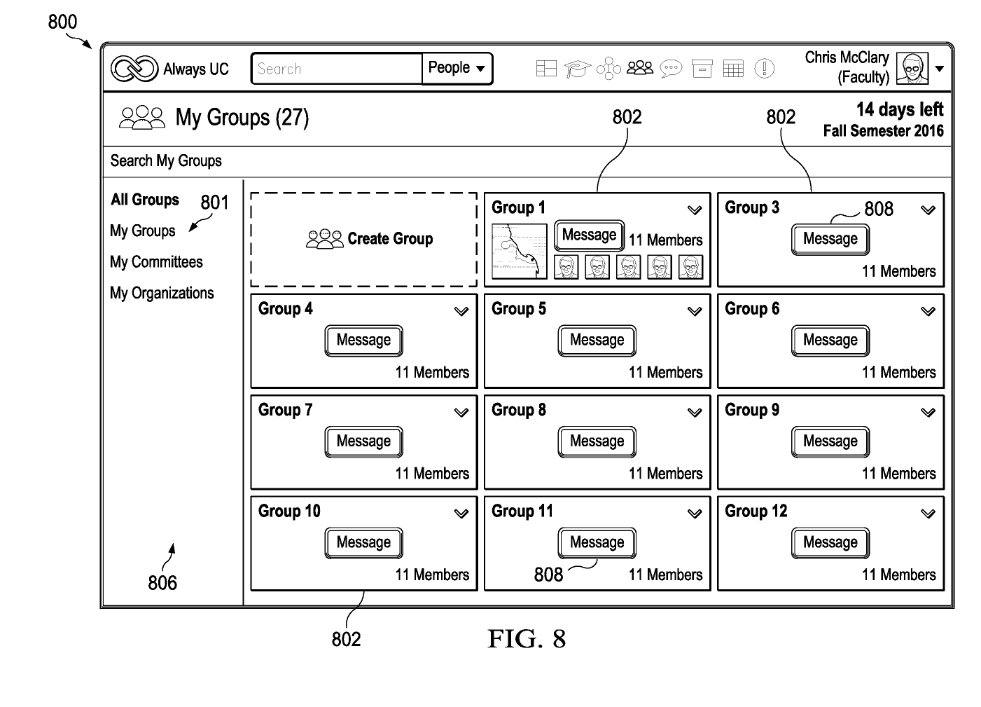

FIG. 8 shows an example screen shot of a “my groups” dashboard display 800 for an individual from FIG. 5 where the “My Groups” link/active-area 503 was activated. Upon activation, the dashboard display 800 displays the current groups the user associated with. The groups are displayed with navigation objects 802 where activation of the navigation object (link or active-area) for the course displays additional levels and information within the group. The navigation area 806 of the display 800 allows the user to further drill down to particular types of groups (all groups, my groups, my committees, for example) 801. As discussed above, some of the groups may be automatically assigned by the interactive digital infrastructure application based upon the user's role. It is also within the scope of the disclosure that a user can sign up for certain groups as well. So while the automatically assigned groups may change based upon the user's role and/or current schedule; voluntary group assignments may persist.

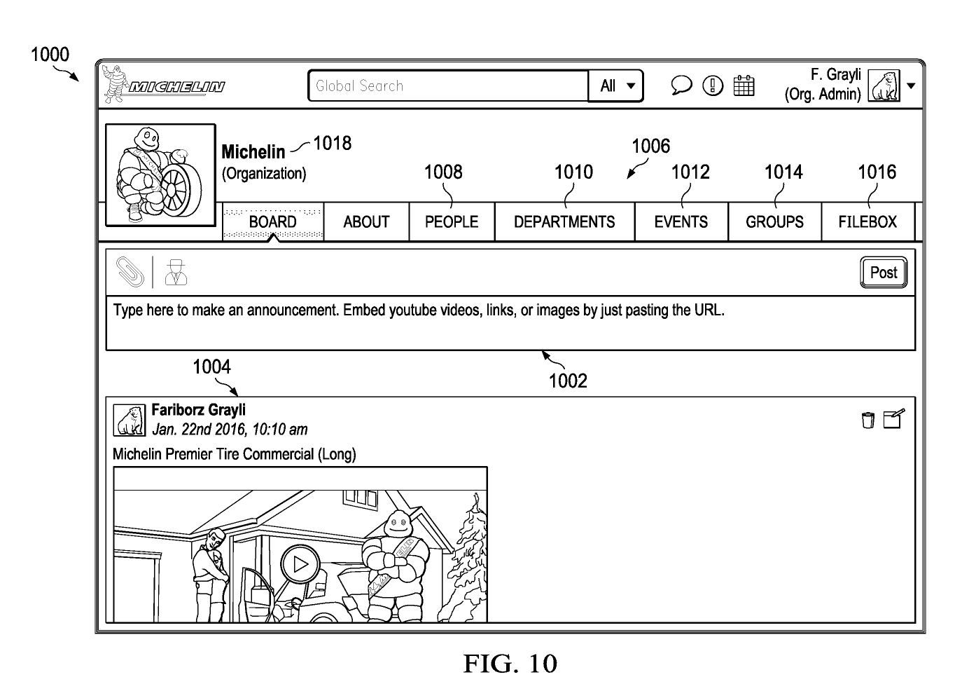

FIG. 8 also provides an illustration of how the messaging functionalities of the interactive digital infrastructure application may be implemented. As shown in FIG. 8, each group 802 associated with the user may include a Message icon or activation area 808 that may be activated by the user to allow the user to compose a message to all other members of that group. FIG. 10, discussed below, shows an example of such a message composition dashboard display. Thus, the current embodiment makes it easy for users to quickly send messages to other users based simply upon context and/or hierarchical levels. So rather than creating email groups or remembering who is in a particular group, by simply activating the Message icon 808 for a particular group 802, the interactive digital infrastructure application automatically generates a message board for composing messages to other members of that group.

Following on this concept, referring back to FIG. 2, each object in the institutional data structure 107 includes a message board in the file (“Board”) associated with that object. In that way, whenever the object is displayed on a dashboard display by the interactive digital infrastructure application, a user may be able to activate a “message” icon associated with that object so that the interactive digital infrastructure application provides a message board display allowing the user to compose messages to all users associated with that specific object. Examples of such messages may include: sending a message to all individuals who were in a classroom at a given time (“did anybody lose a pair of glasses in Biology 101 today?”); sending a message to all individuals scheduled to be in a building at a given time (“can anybody walk me to my dorm room?”); all individuals signed up for a given course (“did anybody get today's assignment?”). Likewise, when a user logs onto the system the user is routed all messages, news feeds, alarms, and other information automatically associated with the user's role in the system.

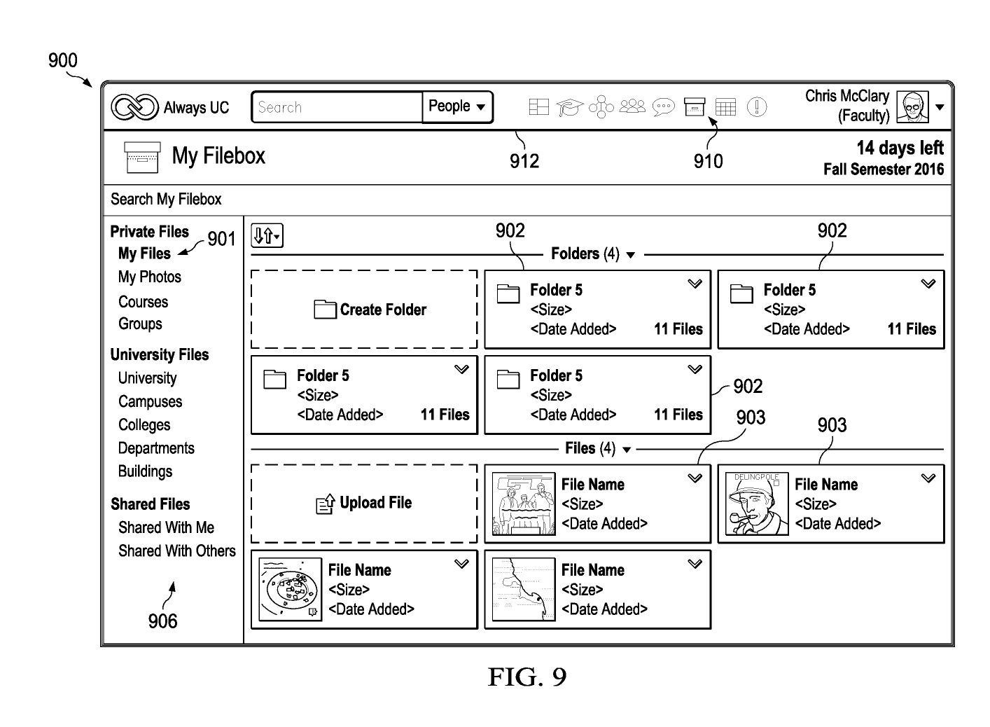

FIG. 9 shows an example screen shot of a “My Filebox” dashboard display 900 for an individual where the My Files navigation icon 910 is activated on the user's toolbar 912. The display section of the dashboard shows file folders 902 which are navigation objects that, when activated, displays in the display section individual documents/files 903 contained in the selected file folder. The FileBox documents are stored in one or more databases accessible to the system (or may be stored in any network-based or cloud-based storage as known). An “Upload File” active area 904 allows the user to upload files from a personal file or network onto the databases accessible by the system. Characteristics of the file or file folder are also displayed, i.e. the size or date of creation. The navigation area 906 of the display 900 allows the user to further drill down to particular categories 901 or groups of documents.

FIG. 10 is an illustration of an example screen shot of a message board dashboard display 1000 (provided by the graphical user interface 105) for an exemplary institution. The message board display 1000 includes an area 1002 for creating posts and/or adding media to be posted to the message board; and also may include previous posts 1004. A navigation bar 1006 may be provided, which include an active area for accessing a personnel directory 1008, an active area for accessing departmental (sub-institutional level) information 1010, an active area for an events calendar 1012, an active area for accessing a groups directory 1014 and an active area for accessing a FileBox 1016. Further an active area 1018 is provided above the navigation bar 1006 for taking the user to the institutional level page.

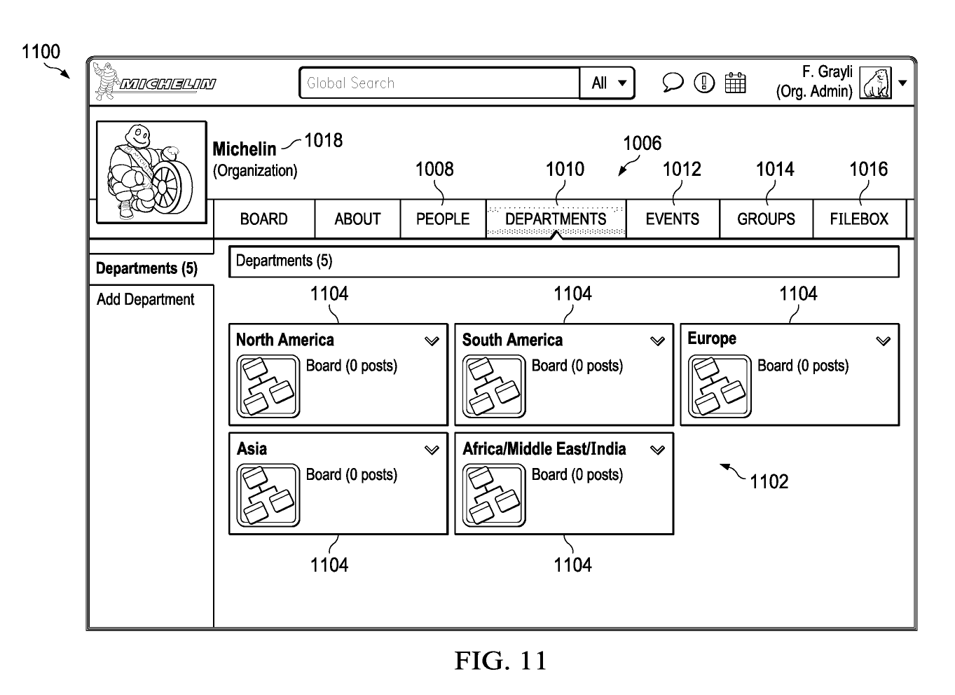

FIG. 11 is an illustration of an example screen shot of the departmental listing display 1100 (provided by the graphical user interface 105) for the exemplary institution of FIG. 10. This screen is accessed upon a user activating the departmental information active area 1010. As can be seen, in the display area 1102, a plurality of department panels 1104 are displayed in which a user can activate to navigate to a display page for the selected department. Again, a navigation bar 1006 is provided that includes an active area for accessing a personnel directory 1008, an active area for accessing departmental (sub-institutional level) information 1010, an active area for an events calendar 1012, an active area for accessing a groups directory 1014 and an active area for accessing a FileBox 1016. Further an active area 1018 is provided above the navigation bar 1006 for taking the user to the institutional level page.

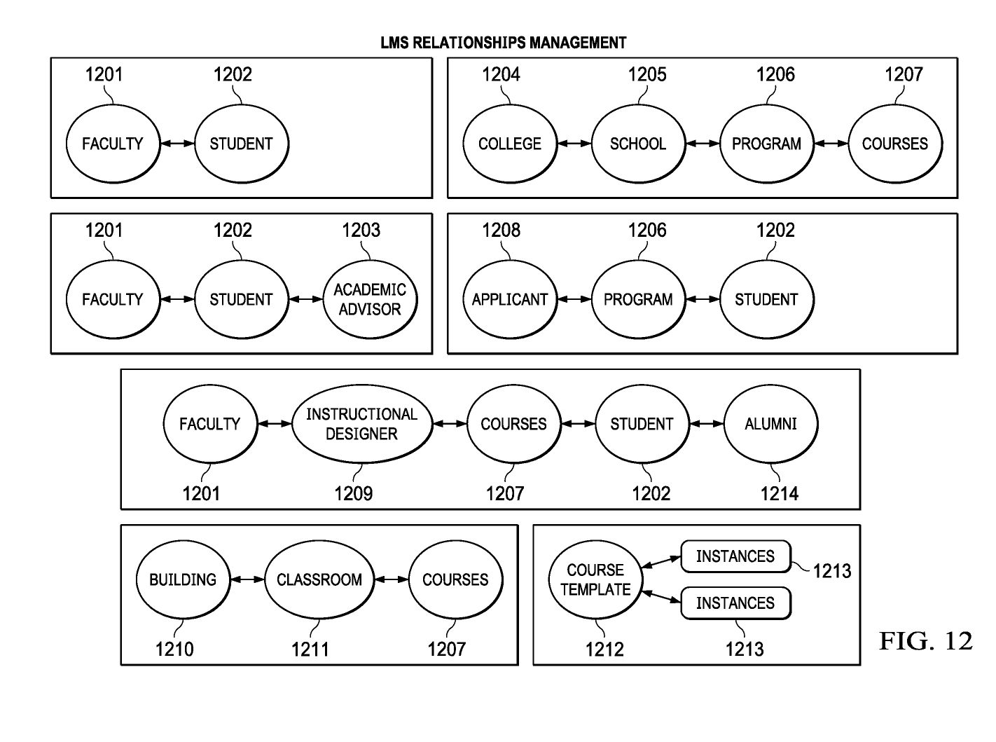

FIG. 12 is a schematic representation of the linking of the object files within the hierarchical databases according to an embodiment of the present disclosure to create relationships. The examples illustrated in FIG. 12 are examples of links between object files contemplated by embodiments of the present disclosure and are not exhaustive of all possible linking of object files. By creating relationships between object files, the files are interconnected by the application. For example, in the educational institution embodiment illustrated in FIG. 12, each circle represents an object file that may be stored in either the institutional hierarchical data structure 107 or the populous data structure 108. A linking relationship logic links the object files. In the populous data structure, a faculty object file 1201 may be linked to a student object file 1202 where a student represented by the student object file is enrolled in a class taught by the faculty member represented by the faculty object file. A further link may include the student object file 1202 linked to an academic advisor object file 1203 for each student's academic advisor. In the institutional data structure, a college object file 1204 may be linked to the school object files 1205 of the schools within that college and the school object files 1205 may be further linked to the program object files 1206 of the programs within each college and even further, the course object files 1207 may be linked to each of the program object files of the programs of which the courses are a part. Applicant object files 1208 may be linked to the program object file 1206 of the program to which an applicant applied. Further, the program object files 1206 in the institutional data structure 107 may also be cross-linked to the student object files 1202 in the populous data structure 108 of the students who are a part of the programs. This linking in turn creates a relationship between an applicant object file 1208 and a student object file 1202. Additional linking includes a faculty member's faculty object file 1201 linked to the instructional designer object file 1209 of the instructional designer who designed the faculty member's course and then the instructional designer object file further cross-linked to the course object file 1207 for the course that was designed. The course object file 1207 may be further linked to the student object files 1202 of the students who enrolled in the course of the course object file. The student object file 1202 then may be further linked to an alumni object file 1214.

FIG. 12 also illustrates the linking between a building object file 1210 with the classroom object file 1211 of a classroom located within the building, and the classroom object file 1211 further linked to the course object files 1207 of the courses held in the classroom of the classroom object file. A course template object file 1212 is linked to instances 1213 associated with the course template (See FIG. 11).

The links between object files created through linking relationship logic allows the embodiments of the current disclosure to perform searches and perform data analysis in ways that otherwise would not be available. For example, the number of students who have taken a particular course may be tracked by the number of student object files 1202 that have been linked to the course object file 1207 of the particular course. Data analysis can be performed on trends observed in the links formed between object files and object files in hierarchical levels. Connections may be suggested for individuals using the relationships created by such linking. For example, a student may be connected to an alumnus of the educational institution through the link of the student's student object file 1202 to a course object file 1207. An alumnus whose alumni object file 1214 is linked to the course object file 1212 as an individual who has once taken the course of the course object file may be connected to the student through that student's link to the course.

The links between the object files can be implemented utilizing the “smart file” technology disclosed in U.S. Pat. No. 7,444,390, entitled Method and Apparatus for Providing a Web-Based Active Virtual File System, the disclosure of which is incorporated by reference. In the smart file technology, sets of rules are associated with the active files. These rules define automatic actions that are performed by the system upon occurrence of triggering events associated with the files. Examples of such automatic actions and associated rules and triggering events with respect to the current disclosure include: time-based rules, for example, change visibility at the end of the term or at any given time; attribute-based rules, for example, when a movie is uploaded then a process may start to convert the movie to MP4 or HLS and to also create different resolutions of the movie to support different bandwidths; impression-based rules, for example, to notify a role when a file has been viewed, or when the number of views has reached a threshold; and/or role-based rules, for example, one role can read/write in certain environments while another role may only be able to read in those environments.

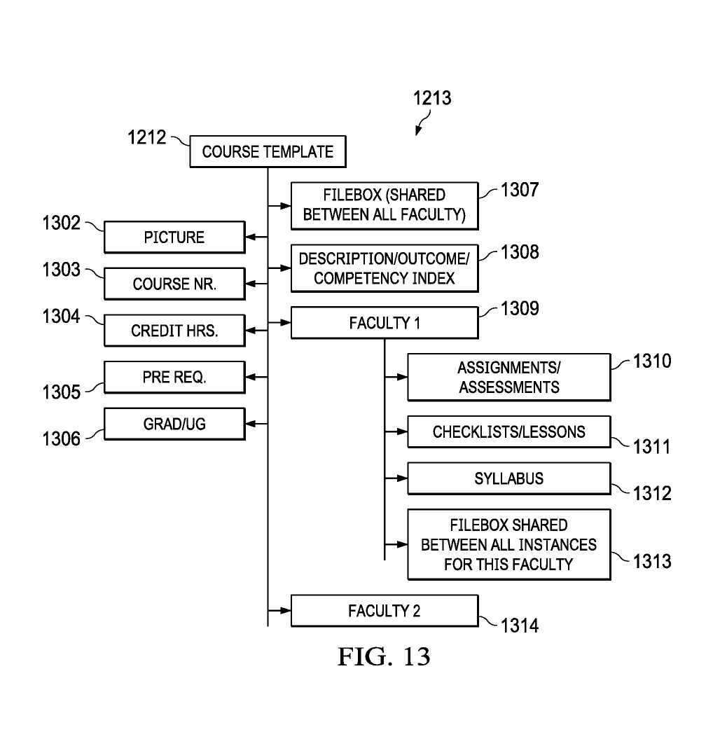

FIG. 13 shows a Course Template file 1212, which includes instances 1213 for allowing a faculty member (or administrator, etc.) to build a course description/file for storage in the institutional data structure 107. Instances 1213 for completion may include a picture associated with the course 1302, the course number 1303, the credit hours for the course 1304, the pre-requisites necessary for the course 1305 and an indication of whether the course is a graduate or undergraduate course 1306. Additional instances include an indication of a FileBox 1307 where files related to the course may be saved and shared between faculty. Instances 1308 in the course template may include a description of the course, outcomes or grades, and a competency index. A Faculty 1 instance 1309 will include an identification/link to a faculty member associated with the course; where such faculty member may provide further instances including assignments and assessments 1310, checklists and lessons 1311, a syllabus 1312 and an indication of an additional FileBox 1313 shared between all instances for faculty. A separate Faculty 2 instance 1314 may also be associated with the Course Template.

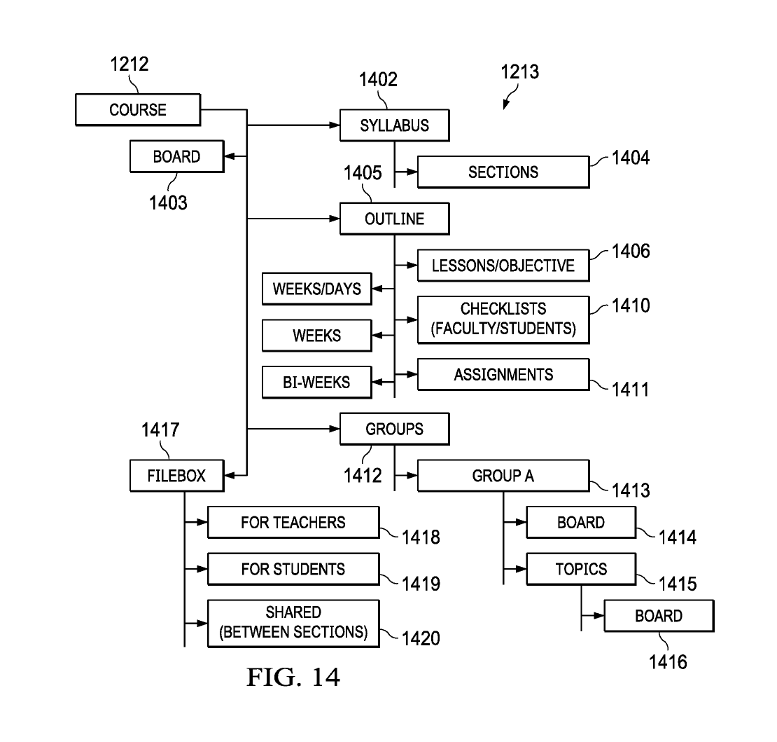

FIG. 14 shows additional instances that may be associated with, and built into a course 1212. The instances 1213 may further include a syllabus 1402, which also includes separate section instances 1404 for the syllabus. The syllabus is connected to an outline 1405 for the course. The outline instance 1405 includes instances of lessons or objectives 1406 for the course, checklists 1410 for the course accessible by the faculty or students, assignments 1411 for the course. The course can also be associated with a group level 1412 in the populous hierarchical data structure 108, and further with a specific group A 1413 which provides access to the course for individuals associated with group A. Additionally, group A may further include a message board 1414 for the group where individuals associated with the group may post messages or topics posted within the group further including message boards 1416 for those particular topics 1415. The course also may include a FileBox instance 1417 for teacher may identify a For Teachers file box 1418 only be accessed by individuals at the Teacher role, and a For Students file box 1419 only accessible for individuals at the Students role, and a Shared file box 1420 contains files accessible by individuals in both the Teacher and Student roles.

The Shared file box 1420 may be used to take care of multiple sections (classes) of the same course taught by a faculty member. Also, another similar shared folder (not shown) may enable sharing of files across all sections taught by different faculty members. Another similar possibility is sharing files with different courses taught by the same faculty member. Another similar possibility is sharing files with courses taught by different faculty members. Sharing of files and folders may be a powerful way to eliminate duplication and save storage space. For example, a faculty member teaching four different courses needs to announce to all students that she is attending a conference, and will have a substitute teacher on that day. By placing that note in the shared folder, all students from the four different courses of that faculty member will be automatically notified (e.g., a notification rule may be associated with the shared file) with one announcement, and will have the ability to see the note. Without such a sharing mechanism, four separate notes/announcements may need to be created.

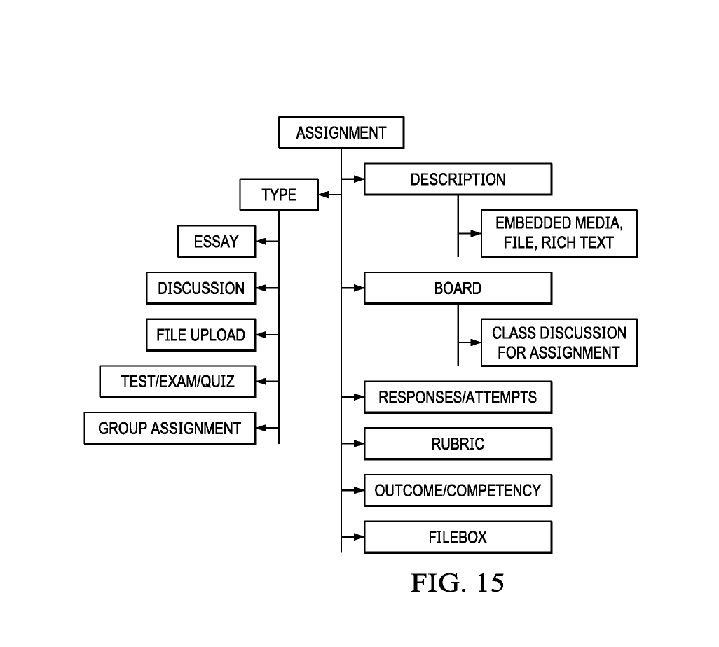

FIG. 15 shows a schematic representation of an assignment file according to an embodiment of the present invention. The assignment file has a Type designation which may be further designated as an essay, discussion, file upload, test/exam/quiz, or group assignment. Activating the Assignment object may provide a description of the assignment where such a description may be an embedded media file, a file, or a rich text file. The assignment may also include a message board where individuals may post messages related to the assignment. The assignment object may also include responses or attempts at the assignment uploaded by individuals, a rubric for the criteria of the assignment, an outcome or competency instance displaying the outcomes of those individuals who attempted the assignment and a FileBox where files related to the assignment may be uploaded, downloaded, or shared.

With such an application, a faculty member, for example, can use a course-builder template to build a course for a term. Initially, when a new term is being designed the faculty member can initiate a new class for that term, and the course-builder will automatically create a first draft of a course schedule including the first day of class, last day of class, holidays, meeting times and the like. Using that initial course schedule, the faculty member may add objects onto the schedule such as assignment objects as described above with respect to FIG. 15 (building these around holidays and other events). Such assignment objects may include many types of rules associated with them such as visibility rules, notification rules, timing rules and availability rules.

Analytical tools are also associated with the system. Data points are accumulated over time and stored for use in generating such analytics. For example, the system will keep track of the students, the courses taken, their grades, their degrees, their activities with the institution after graduation and the like. Analytics will therefore be able to run against such data to determine many things, such as percentages of students who graduate from certain programs, the courses that are most likely taken by students who are in a certain program, the number of students who donate money to the institution following graduation, and the like. Certainly, the role of a person within the institution may control the amount of access that such person may have to run or see such analytics.

It is also within the scope of the current disclosure that user may access interactive digital infrastructure application via hand-held or other mobile computing devices that include geo-location capabilities (such as smart phones). With such a mobile application, part of the user's file associated with the user in the populous data structure 108 may include the location information. With such information part of the user's file, the interactive digital infrastructure application may be able to locate buildings or other resources near the individual, locate other people near the individual, locate events in the vicinity, and so forth. Messaging applications will allow users to send messages to individuals near certain locations—for example the messaging application may be used to message everybody studying in a library to create a group to walk back to their home or dormitory safely.

While the above embodiments have been discussed in application for an educational institution, it should be apparent to those of ordinary skill in the art that the interactive digital infrastructure application may be used in other types of institutions.

Following from the above description and invention summaries, it should be apparent to those of ordinary skill in the art that, while the systems and processes herein described constitute embodiments of the present invention, it is to be understood that the invention is not limited these precise systems and processes and that changes may be made therein without departing from the scope of the invention as defined by the claims. Additionally, it is to be understood that the invention is defined by the claims and it is not intended that any limitations or elements describing the embodiments set forth herein are to be incorporated into the meaning of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed:

1. An interactive digital infrastructure application comprising:
a first hierarchical data structure including a plurality of hierarchical levels, including,
a. a higher institutional level having at least one institutional file pertaining to an institution,
b. an intermediate geographic level having a plurality of geographic files pertaining to geographic locations associated with the institution, and
c. a lower resource level having a plurality of resource files pertaining to resources associated with the geographic locations;
a populous data structure including a plurality of individual files pertaining to individual people associated with the institution; and
a network-based, interactive software tool having access to the first hierarchical data structure and to the populous data structure, the software tool providing an interactive graphical user interface dashboard accessible to each of the individual people associated with the institution;
wherein the institutional file includes institutional information and identities of files in a next lower hierarchical level of the first hierarchical data structure;
wherein the each of the plurality of geographic files include associated geographic information, identities of files in a next upper hierarchical level of the first hierarchical data structure, and identities of files in a next lower hierarchical level of the first hierarchical data structure;
wherein each of the plurality of resource files include associated resource information and identities of files in a next upper hierarchical level in the first hierarchical data structure; and
wherein each dashboard displays information from at least one file in the first hierarchical data structure and further displays navigation objects pertaining to hierarchical files above and/or below the at least one file in the first hierarchical data structure to allow a user to navigate through files in the first hierarchical data structure by activating navigation objects in the dashboard display.

2. The interactive digital infrastructure application of claim 1, further comprising a legacy logical layer interface between a legacy database silo and the first hierarchical data structure, the logical layer interface providing access to information in the legacy database silo for display in at least one dashboard.

3. The interactive digital infrastructure application of claim 1, wherein the populous data structure is a second hierarchical data structure, and wherein levels within the second hierarchical data structure pertain to roles of individuals within the institution.

4. The interactive digital infrastructure application of claim 3, wherein each individual file includes information pertaining to the individual and includes identities of files above and/or below the individual file in the second hierarchical data structure.

5. The interactive digital infrastructure application of claim 4, wherein each dashboard displays information from at least one file in the second hierarchical data structure and further displays navigation objects pertaining to hierarchical files above and/or below the at least one file in the second hierarchical data structure to allow a user to navigate through files in the second hierarchical data structure by activating navigation objects in the dashboard display.

6. The interactive digital infrastructure application of claim 5, wherein:
the institution is a school;
the geographic locations include at least one of (i) buildings within the school and (ii) rooms within the school; and
the resources include equipment within the geographic locations.

7. The interactive digital infrastructure application of claim 6, wherein levels within the populous data structure include:
an administrative level;
a teacher level; and
a student level.

8. The interactive digital infrastructure application of claim 7, wherein levels within the second hierarchical data structure further include at least one of:
an alumni level;
an employee level; and
a vendor level.

9. The interactive digital infrastructure application of claim 5, wherein levels within the second hierarchical data structure include a group level having a plurality of group files pertaining to the groups between individuals within the institution.

10. The interactive digital infrastructure application of claim 5, wherein levels within the second hierarchical data structure include an event level having a plurality of event files pertaining to past or future events attended by individuals within the institution.

11. The interactive digital infrastructure application of claim 5, further comprising a social networking logical layer interface between at least one social networking system and the populous data structure, the interface providing access to information on the social networking systems by the populous data structure.

12. The interactive digital infrastructure application of claim 5, wherein the interactive software tool suggests connections between individuals within the institution where the connection is based on a predetermined flag associated with the individual files of the connected individuals; further wherein the connection is displayed in each dashboard.
The interactive digital infrastructure application of claim 5 further comprising an analysis tool that analyzes the files of each hierarchical level of the first and second hierarchical data structures based on predetermined flags and provides to the interactive software tool connections based on the predetermined flags; wherein the interactive software tool displays the connections.

13. The interactive digital infrastructure application of claim 5, wherein the interactive software tool performs the steps of:
comparing individual files in the second hierarchical data structure;
identifying similarities in the information of a plurality of individual files;
suggesting connections between individuals based on the similarities identified in the individuals' files.

14. The interactive digital infrastructure application of claim 1, wherein the resource information includes at least one of:
(i) warrantee information associated with the resource;
(ii) user information associated with the resource;
(iii) vendor information associated with the resource;
(iv) service schedule information associated with the resource; and
(v) geographic location information associated with the resource.

15. The interactive digital infrastructure of claim 14, wherein the location information of a resource is updated when it is removed from a geographic location or is relocated to a different geographic location.

16. The interactive digital infrastructure of claim 7, wherein the dashboard allows an individual in the teacher level to create and share files, wherein the information in the file pertains to at least one of:
(i) class schedule information;
(ii) curriculum information; and
(iii) assignment information.

17. An interactive digital infrastructure application comprising:
a first hierarchical data structure including a plurality of hierarchical levels, including at least two of,
a. a higher institutional level having at least one institutional file pertaining to an institution,
b. an intermediate geographic level having a plurality of geographic files pertaining to geographic locations associated with the institution,
c. an intermediate sub-institutional level having a plurality of sub-institutional files pertaining to sub-institutions within the institution, and
d. a lower resource level having a plurality of resource files pertaining to resources associated with the geographic locations;
a populous data structure including a plurality of individual files pertaining to individual people associated with the institution, said plurality of individual files including information pertaining to each individual's role within the institution; and
a network-based, interactive software tool having access to the first hierarchical data structure and to the populous data structure, the software tool providing an interactive graphical user interface dashboard accessible to each of the individual people associated with the institution;
wherein the interactive software tool includes a social network application that has been automatically established for the plurality of individuals based, at least in part, upon each individual's role within the institution.

18. The interactive digital infrastructure application of claim 17, wherein the social network application automatically assigns each individual to at least one social network group based upon the individual's role within the institution.

19. The interactive digital infrastructure application of claim 17, wherein the social network application automatically assigns each individual to access to one or more hierarchical levels within the first hierarchical data structure based upon the individual's role within the institution.

20. The interactive digital infrastructure application of claim 17, wherein the social network application automatically assigns each individual to one or more categories of messaging based upon the individual's role within the institution.

21. The interactive digital infrastructure application of claim 17, wherein the social network application automatically assigns each individual access to a sub-set of information within the first hierarchical data structure based upon the individual's role within the institution.

22. The interactive digital infrastructure application of claim 17, wherein the social network application automatically assigns institutional connections between the plurality of individuals based, at least in part, upon the individuals' roles within the institution.

23. The interactive digital infrastructure application of claim 22, wherein the social network application automatically reassigns institutional connections between the plurality of individuals based, at least in part, upon changes to the individuals' roles within the institution.

24. The interactive digital infrastructure application of claim 23, wherein the social network application assigns voluntary connections between the plurality of individuals based upon users' interactions with the social network application and wherein the social network application does not reassign the voluntary connections based upon changes to the individuals' roles within the institution.
